(19) United States
(12) Patent Application Publication
(10) Pub. No.: US 2018/0260563 A1
(43) Pub. Date: Sep. 13, 2018

(54) COMPUTER SYSTEM FOR EXECUTING ANALYSIS PROGRAM, AND METHOD OF MONITORING EXECUTION OF ANALYSIS PROGRAM

(71) Applicant: HITACHI, LTD., Tokyo (JP)

(72) Inventor: Takanobu TSUNODA, Tokyo (JP)

(73) Assignee: HITACHI, LTD., Tokyo (JP)

(21) Appl. No.: 15/800,793

(22) Filed: Nov. 1, 2017

(30) Foreign Application Priority Data
Mar. 9, 2017 (JP) 2017-045026

(51) Int. Cl. G06F 21/56; G06F 21/64; G06F 17/30

(52) U.S. Cl. CPC G06F 21/566; G06F 2221/033; G06F 17/30312; G06F 21/64

(57) ABSTRACT

A computer system for managing analysis source data receives and executes an analysis program. The computer system calculates one or more types of deviations, based on a behavior of the analysis program. The computer system controls whether or not to output, to the outside of the computer system, output data that is data output as a result of analysis by the analysis program, based on the one or more types of calculated deviations.

### CROSS-REFERENCE TO PRIOR APPLICATION

This application relates to and claims the benefit of priority from Japanese Patent Application No. 2017-045026 filed on Mar. 9, 2017, the entire disclosure of which is incorporated herein by reference.

### BACKGROUND

The present invention generally relates to protection of data pertaining to analysis.

It is desirable that data pertaining to analysis (e.g., at least one of analysis source data and analysis result data) be appropriately protected. As a technology pertaining to data protection, for example, a technology disclosed in Japanese Patent Laid-Open No. 2014-095931 has been known. The system disclosed in Japanese Patent Laid-Open No. 2014-095931 discloses disclosable data to allow analysis while protecting secret data, and notifies parties and organizations having different access levels of resultantly acquired information.

### SUMMARY

A plurality of edge systems, and a core system that can communicate with the edge systems have been known. Each edge system is a computer system provided at a location (e.g., a factory or a branch office). The core system is a computer system provided at a core location (e.g. a main office).

In each of the edge systems, analysis source data is accumulated. The core system collects the analysis source data from each of the edge systems and executes an analysis program, thereby allowing analysis to be executed using the collected pieces of analysis source data.

Unfortunately, in at least one edge system, the analysis source data is often enormous (e.g., time-series data collected from each of many sensors). Accordingly, transfer of the pieces of analysis source data from the edge systems to the core system has low efficiency.

It can be considered that each edge system serves as an analysis system, more specifically, execution of the analysis program provided by the core system allows each edge system to execute analysis using the analysis source data managed by the corresponding edge system and to transmit analysis result data to the core system.

However, the analysis program to be executed is not necessarily always trustable. For example, it can also be considered that an analysis program may be provided by a system of another corporation. However, such an analysis program is not necessarily a trustable program. Furthermore, it can be considered that even if the analysis program is a trustable program at the time of reception (installation), this program may become an untrustable program (e.g. infection by malware).

There is a risk that execution of an untrustable analysis program leaks data pertaining to analysis. More specifically, for example, at least one of leakage of at least a part of the analysis source data, leakage of at least a part of the analysis result data, and inappropriateness of the analysis result data (a wrong analysis result) can occur.

A computer system for managing analysis source data receives and executes an analysis program. The computer system calculates one or more types of deviations, based on the behavior of the analysis program. The computer system controls whether or not to output, to the outside of the computer system, output data that is data output as a result of analysis by the analysis program, based on the one or more types of calculated deviations.

Data pertaining to analysis can be prevented from being leaked.

### BRIEF DESCRIPTION OF THE DRAWINGS

FIG. 1 shows an overall configuration of a system according to an embodiment;

FIG. 2 shows a physical configuration of an edge system;

FIG. 3 shows logical configurations of the edge system and a core system;

FIG. 4 shows a detailed physical configuration of the edge system;

FIG. 5 shows a specific example of data demand information; and

FIG. 6 shows a flow of processes performed by the edge system.

### DETAILED DESCRIPTION OF THE EMBODIMENT

In the following description, an “interface unit” includes one or more interfaces. The one or more interfaces may be one or more interface devices of the same type (e.g., one or more NICs (Network Interface Cards)), or two or more interface devices of different types (e.g., NIC and HBA (Host Bus Adapter)).

In the following description, a “storing unit” includes one or more memories. Among the storing units, at least one memory may be a volatile memory. The storing unit is mainly used for processes by a processor unit. The storing unit may further include one or more nonvolatile memory devices (e.g., HDDs (Hard Disk Drives) or SSDs (Solid State Drives)).

In the following description, the “processor unit” includes one or more processors. The one or more processors are typically microprocessors, such as CPUs (Central Processing Units). Each of the one or more processors may be a single-core or multi-core processor. The processor may include a hardware circuit that performs a part of or the entire process.

In the following description, a function may sometimes be described using a representation of “kkk unit”. The function may be achieved by the processor unit executing one or more computer programs, or by one or more hardware circuits (e.g., FPGAs (Field-Programmable Gate Arrays) or ASICs (Application Specific Integrated Circuits)). In the case where the function is achieved by the processor unit, a predetermined process is performed appropriately using the storing unit (e.g., a memory) and/or the interface unit (e.g. a communication port). Consequently, the function may be at least a part of the processor unit. The process described with a function serving as the subject of a sentence may be a process performed by the processor unit or an apparatus that includes the processor unit. The processor unit may include a hardware circuit that performs a part of or the entire process. The program may be installed from a program source into the processor. The program source may be, for example, a program distributing computer or a computer-readable recording medium (e.g., a non-transitory recording medium). The description of each function is only one example. Alternatively, multiple functions may be integrated into a single function, or a single function may be divided into multiple functions.

In the following description, a “computer system” may be one or more computers. At least one computer may be a general-purpose computer. For example, at least one physical computer may execute a virtual computer (e.g., VM (Virtual Machine)) or execute SDx (Software-Defined anything). For example, SDS (Software Defined Storage) (an example of a virtual storage apparatus) or SDDC (Software-defined Datacenter) may be adopted as SDx.

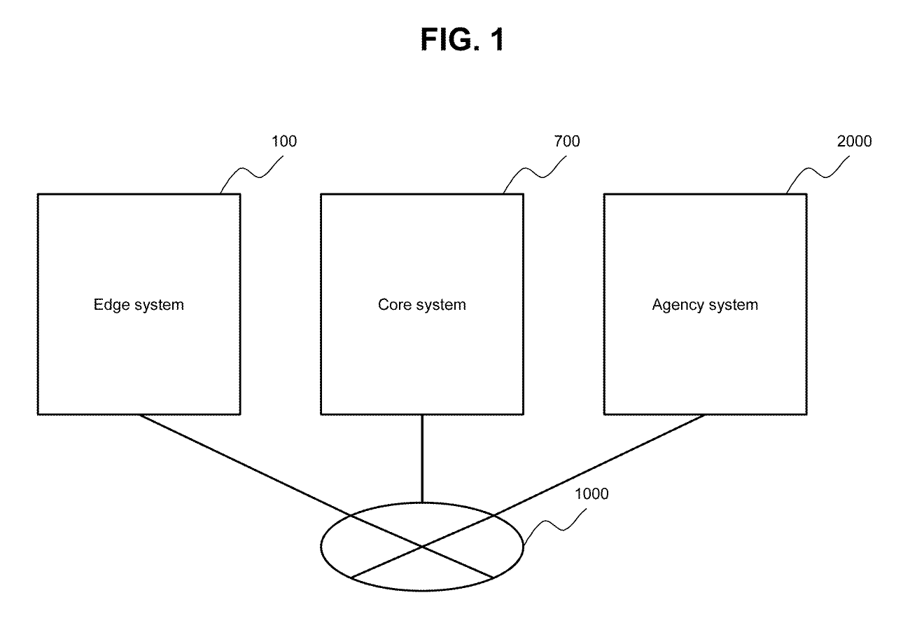

FIG. 1 shows an overall configuration of a system according to an embodiment.

An edge system 100, a core system 700, and an agency system 2000 are coupled to a communication network (e.g., the Internet) 1000. Each of the systems 100, 700 and 2000 is a computer system. The numbers of systems 100, 700 and 2000 are each one or more. For the sake of simplifying the description, in the description of this Embodiment, the numbers of systems 100, 700 and 2000 are each one.

The edge system 100 is an example of an analysis system, that is, an example of a computer system that executes an analysis program. The edge system 100 may be a computer system resides at a location. In this Embodiment, the edge system 100 receives the analysis program from the core system 700 via the communication network 1000 and executes this program, and transmits analysis result data to the core system 700 via the communication network 1000. A source that provides the analysis program may be a computer system other than the systems 100 and 700, such as the agency system 2000, instead of or in addition to the core system 700.

The core system 700 provides the analysis program for the edge system 100 via the communication network 1000, and receives the analysis result data from the edge system 100 via the communication network 1000 and stores this data.

The agency system 2000 is a computer system that performs at least one of providing and execution of the analysis program on behalf thereof. More specifically, for example, the agency system 2000 may provide the edge system 100 with an analysis program selected from among multiple analysis programs. The agency system 2000 may receive and execute the analysis program, and transmit the analysis result data to the core system 700 on behalf of the edge system 100. The agency system 2000 is optional (that is, this system is not necessarily provided). The description of the agency system 2000 is hereinafter omitted.

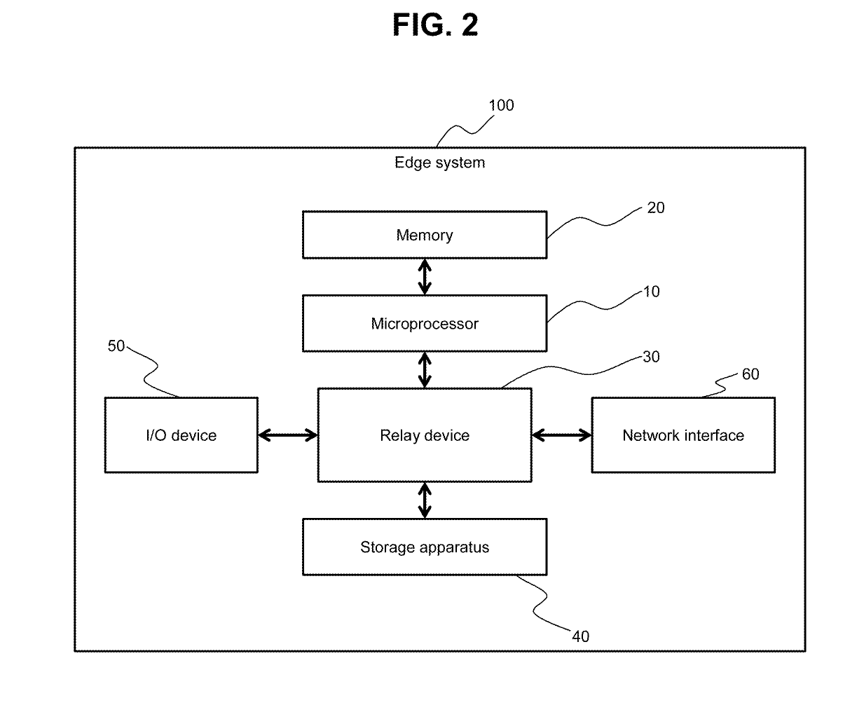

FIG. 2 shows the physical configuration of the edge system 100.

The edge system 100 includes a network interface 60, an I/O (Input/Output) device 50, a storage apparatus 40, a relay device 30, a memory 20, and a microprocessor 10.

The network interface 60 is an example of an interface unit, and is coupled to the communication network 1000. The I/O device 50 is an input device (e.g., a keyboard and a pointing device), and an output device (e.g., a display device). The storage apparatus 40 stores analysis source data. The storage apparatus 40 may reside outside of the edge system 100 in a manner capable of communicating with the edge system 100. The relay device 30 relays communication of each of the network interface 60, the I/O device 50, the storage apparatus 40 and the processor 10. The processor 10 executes the program stored in the memory 20, thereby reading data from the storage apparatus 40 into the memory 20 and referring to or updating the data in the memory 20. The memory 20 is, for example, a volatile semiconductor memory, such as DRAM (Dynamic Random Access Memory). Alternatively, the memory 20 may be a nonvolatile semiconductor memory, such as flash memory. Between the memory 20 and the storage apparatus 40, at least the memory 20 is an example of the storing unit. The processor 10 is an example of the processor unit.

The physical configuration of the edge system 100 has been described in detail. The core system 700 may have an identical or similar physical configuration.

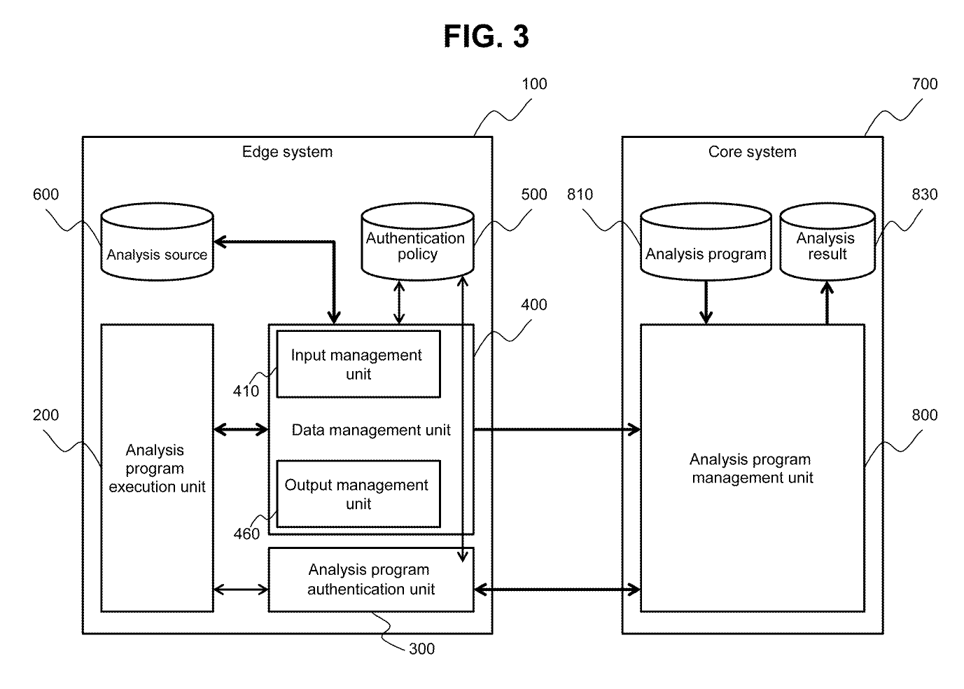

FIG. 3 shows the logical configurations of the edge system 100 and the core system 700.

The core system 700 includes an analysis program storage resource 810, an analysis program management unit 800, and an analysis result storage resource 830. Each of the storage resources 810 and 830 may be at least a part of a storage area provided by the storage unit included in the core system 700, or at least a part of a storage area provided by a storage apparatus that resides out of the core system 700.

The analysis program storage resource 810 stores one or more analysis programs. The analysis program management unit 800 acquires the analysis program, which is to be provided, from the analysis program storage resource 810, and provides the acquired analysis program for the edge system 100. The analysis program management unit 800 receives the analysis result data, which is the execution result of the provided analysis program, and stores the received analysis result data in the analysis result storage resource 830.

The edge system 100 includes an analysis source storage resource 600, an authentication policy storage resource 500, an analysis program authentication unit 300, an analysis program execution unit 200, and a data management unit 400. Each of the storage resources 600 and 500 may be at least a part of a storage area provided by the storage unit (at least the memory 20 between the memory 20 and the storage apparatus 40) included in the edge system 100, or at least a part of a storage area provided by a storage apparatus that resides out of the edge system 100.

The analysis source storage resource 600 stores the analysis source data. The authentication policy storage resource 500 stores authentication policy data (e.g. database) that is data representing an authentication policy.

The analysis program authentication unit 300 receives the analysis program from the core system 700, and determines whether the received analysis program is correct or not on the basis of the authentication policy data. When the determination result is true, the analysis program authentication unit 300 provides the received analysis program for the analysis program execution unit 200.

The analysis program execution unit 200 executes the analysis program having been affirmatively passed by the analysis program authentication unit 300. The effects as the execution result of the analysis program are enclosed in the analysis program execution unit 200. More specifically, for example, the analysis program execution unit 200 is a sandbox.

The data management unit 400 monitors the analysis program execution unit 200, and executes control according to the monitoring result. The data management unit 400 includes an input management unit 410, and an output management unit 460. The input management unit 410 acquires input data (at least a part of the analysis source data) that is data used by the analysis program from the analysis source storage resource 600, and inputs the data into the analysis program execution unit 200. The output management unit 460 receives the analysis result data that is the execution result of the analysis program, from the analysis program execution unit 200, and transmits the data to the core system. At least one of the input management unit 410 and the output management unit 460 executes control according to the authentication policy data, as required.

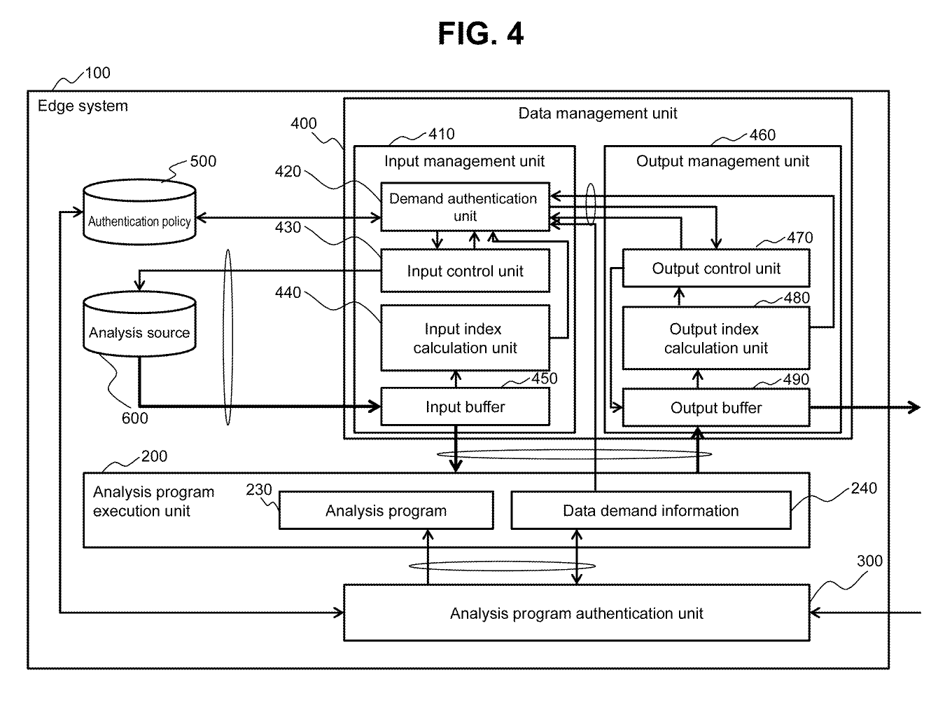

FIG. 4 shows the detailed physical configuration of the edge system 100.

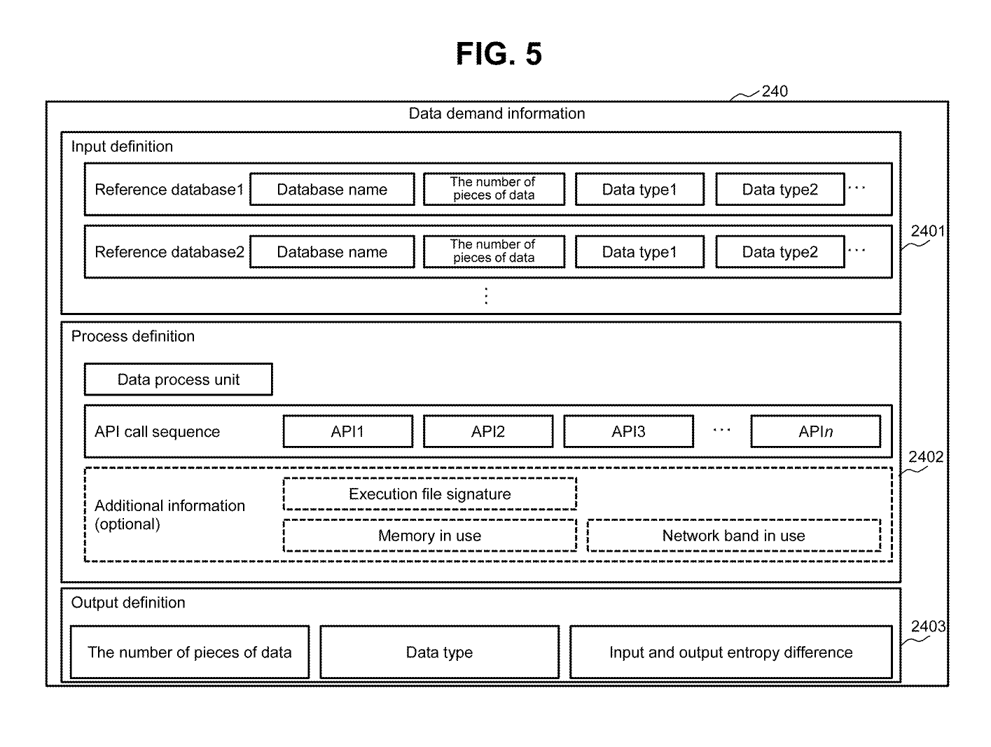

The analysis program execution unit 200 executes the analysis program 230 having been affirmatively passed by the analysis program authentication unit 300 (i.e., authenticated by the authentication unit 300). Data demand information 240 is associated with the analysis program 230. The data demand information 240 includes information that represents the behavior of the analysis program 230 with which the information 240 is associated (in other words, information that contains the self-reported content of the analysis program 230). FIG. 5 shows a specific example of the data demand information 240. That is, the data demand information 240 includes, for example, an input definition 2401, a process definition 2402, and an output definition 2403. The input definition 2401 is information that indicates the definition pertaining to input data that the analysis program 230 refers to in analysis (e.g., the database name, the number of pieces of data, and the data type of each database). The process definition 2402 is information indicating the definition pertaining to the process (analysis) using input data (e.g., a data process unit, API (Application Programming Interface) call sequence (API call order)). The output definition 2403 is a definition pertaining to output data output as the result of analysis (e.g., the number of pieces of data, data type, input and output entropy difference (the difference between the entropy of input data and the entropy of output data)).

The input management unit 410 includes a demand authentication unit 420, a data input control unit 430, an input index calculation unit 440, and an input buffer 450.

Management of input data input into the analysis program 230 is, for example, as follows.

The demand authentication unit 420 acquires the authentication policy pertaining to the analysis program 230, from the authentication policy storage resource 500. Authentication policy data in the authentication policy storage resource 500 indicates the authentication policy for each analysis program. The authentication policy indicates, for example, a dynamic API call sequence, and the amount and range (e.g., address range) of data to be read from the analysis source storage resource 600 for analysis. The demand authentication unit 420 determines the permissibility of access to the analysis source data in the analysis source storage resource 600 on the basis of the acquired authentication policy and the data demand information 240 associated with the analysis program 230. When the access permissibility is affirmatively determined, the demand authentication unit 420 also determines read target data (e.g., read source address range) in the analysis source data in the analysis source storage resource 600 on the basis of the data demand information 240 associated with the analysis program 230. When the access permissibility is affirmatively determined, the demand authentication unit 420 transmits a read instruction for access to the read target data (e.g., a read instruction with which the read source address range is associated), to the data input control unit 430.

The data input control unit 430 reads data from the analysis source storage resource 600 in response to the read instruction from the demand authentication unit 420. The data input control unit 430 stores the read data in the input buffer 450.

The input index calculation unit 440 calculates the input index, and notifies the demand authentication unit 420 of the calculated input index. The “input data” is the entire data read from the analysis source storing resource 600 for analysis. For example, in a case where the data is read on a predetermined data unit basis (in other words, a case where the data is read multiple times), each of individual pieces of read data is an input data element, and all the pieces of read data (a set of input data elements) are the input data. The “input index” is an index pertaining to the input data. The input index is, for example, the amount of input data (the data amount of input data), and the input data entropy. The input index calculation unit 440 may update the input index every time the input data element is stored in the input buffer 450. When all the input data elements are read, this unit may calculate (determine) the input index on the input data, and notify the demand authentication unit 420 of the input index.

Every time a certain amount or a certain range of data is stored in the input buffer 450, data is input from the input buffer 450 into the analysis program 230, and is analyzed by the analysis program 230 executed by the analysis program execution unit 200. The demand authentication unit 420 monitors the behavior of the analysis program 230, and accumulates information representing the monitored behavior, as a part of the authentication policy of the analysis program 230, in the authentication policy storage resource 500. That is, the authentication policy for the analysis program 230 is updated. In a case where the same analysis program 230 is executed by the analysis program execution unit 200 on the basis of the updated authentication policy in the future, improvement in the authentication process speed on the analysis program 230 is expected, and even if the behavior of the analysis program 230 deviates from the normal behavior (analysis operation), the event of the deviation is expected to be detected.

Management of output data output from the analysis program 230 is, for example, as follows.

The demand authentication unit 420 determines the permissibility of data output on the basis of at least one of the magnitude of behavior deviation and the magnitude of index deviation, and notifies a data output control unit 470 of the determined data output permissibility.

The “behavior deviation” is the deviation between the behavior monitored on the analysis program 230 and the normal behavior indicated by the authentication policy corresponding to the analysis program 230. It is believed that the behavior deviation is large if the analysis program 230 having been affirmatively passed by the analysis program authentication unit 300 (i.e., an authenticated program 230) is infected with malware at the time of execution. In such a case, the denial (disablement) of data output can prevent data from leaking in an unauthorized manner.

The “index deviation” is the deviation between the input index and the output index, more specifically, the deviation in the amount of data that is the deviation between the amount of input data and the amount of output data, and the entropy deviation between the input data entropy and the output data entropy. The analysis is characterized in that the amount of output data tends to be smaller than the amount of input data. Accordingly, if the deviation in the amount of data is smaller than a predetermined amount, the possibility that the analysis program 230 is an untrustable program is high. On the other hand, if the output data is compressed, the amount of output data becomes small. Consequently, the deviation in the amount of data can be apparently large. Accordingly, checking based on the magnitude of the entropy deviation is effective. For example, the following details may be adopted.

(b1-1) The demand authentication unit 420 determines whether the deviation in the amount of data is equal to or larger than a first threshold or not.
(b1-2) When the determination result of (b1-1) is true, the demand authentication unit 420 further determines whether the entropy deviation is equal to or larger than a second threshold or not.
(b2) When the determination result of (b1-2) is also true, the demand authentication unit 420 notifies the data output control unit 470 of the data output permission. The thus notified data output control unit 470 transmits the output data in an output buffer 490 to the core system 700.

The threshold with which at least one of the magnitudes of behavior deviation and index deviation is compared may be configured as a part of the authentication policy by a user through a predetermined user interface (e.g. GUI (Graphical User Interface)).

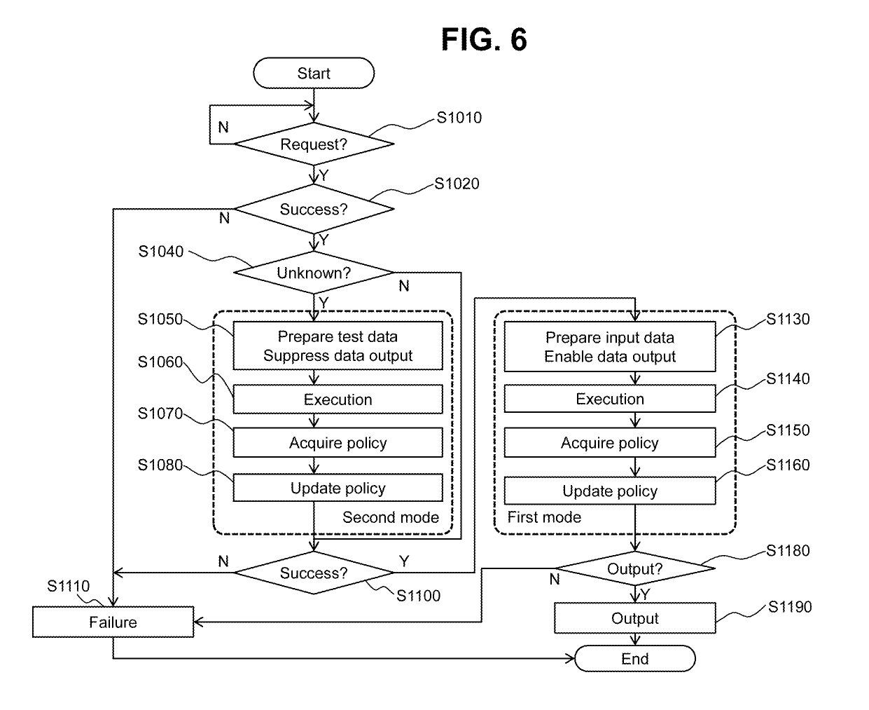

In this Embodiment, in addition to a first mode for monitoring a known analysis program and controlling the permissibility of data output according to the monitoring result, a second mode for performing test-monitoring of an unknown analysis program and denying data output (causing data output to be disabled) irrespective of the monitoring result is defined. Each of the first and second modes is described later with reference to FIG. 6.

The data output control unit 470 controls data output from the output buffer 490 according to the notification from the demand authentication unit 420 (notification on the data output permissibility).

An output index calculation unit 480 calculates the output index, and notifies the demand authentication unit 420 of the calculated output index. The “output data” is data as a result of the analysis performed using the input data. For example, in a case where data is output with respect to each part of the input data, the data output is an output data element, and data in which all the pieces of output data are aggregated is the output data. The output data is stored by the analysis program 230 in the output buffer 490. The “output index” is an index pertaining to the output data. The output index is, for example, the amount of output data (the data amount of output data), and the output data entropy.

FIG. 6 shows a flow of processes performed by the edge system 100.

When the analysis program authentication unit 300 receives an analysis request (S1010: Y), this unit determines whether the analysis program designated by the analysis request (hereinafter, a target analysis program) is correct or not (S1020). For example, this determination may be made on the basis of metadata on the analysis program (e.g., the source that provides the analysis program, or a creator of the analysis program). When the determination result of S1020 is false (S1020: N), the analysis program authentication unit 300 transmits an authentication failure notification to the request source of the analysis request (core system 700) (S1110).

When the determination result of S1020 is true (S1020: Y), the analysis program authentication unit 300 instructs the analysis program execution unit 200 to execute the target analysis program. In a case where the target analysis program is a program having already been received and executed, information that can identify the analysis program (e.g., a program ID) may be designated in the analysis request described above, or the target analysis program (and its data demand information) may be associated with this request (in the latter case, the analysis program may be removed by the data management unit 400 from the edge system 100 every analysis completion). On the other hand, in a case where the target analysis program is an analysis program to be received and executed at the first time, the target analysis program (and its data demand information) may be associated with the analysis request described above.

When the analysis program execution unit 200 is instructed to execute the target analysis program, reception of the instruction of executing the target analysis program by the analysis program execution unit 200 is detected by the data management unit 400 that monitors the analysis program execution unit 200. The analysis program execution unit 200 is the closed environment (e.g., a sandbox). Consequently, even if the target analysis program is an untrustable program, the range of effect of the execution result is enclosed in the analysis program execution unit 200.

The data management unit 400 determines whether the target analysis program is an unknown analysis program or not (S1040). For example, if the history (behavior) of execution of the target analysis program in the past is not stored as a part of the authentication policy in the authentication policy storage resource 500, the target analysis program is determined as an unknown analysis program.

When the determination result of S1040 is true (S1040: Y), the data management unit 400 enters the second mode (S1050 to S1080).

First, the data management unit 400 prepares at least a part of test data for executing the target analysis program in the input buffer 450, and configures the data output suppression (S1050). The test data may be dummy data having the same amount of data as the amount of data identified by the input definition of the data demand information, or data read from the analysis source data according to the input definition of the data demand information. The configuration of the data output suppression allows the data management unit 400 to prevent the data output as a result of analysis and stored in the output buffer 490 from being output to the outside of the data management unit 400 (out of the edge system 100).

Next, the data management unit 400 permits the analysis program execution unit 200 to execute the target analysis program (S1060). The analysis program execution unit 200 thus executes the target analysis program.

Next, the data management unit 400 executes 51070. For example, the data management unit 400 acquires the authentication policy pertaining to the target analysis program, from the authentication policy storing resource 500. The data stored in the input buffer 450 is input into the analysis program 230 and analyzed, and data as an analysis result is stored in the output buffer 490. The data management unit 400 monitors the behavior of the target analysis program.

Lastly, the data management unit 400 updates the authentication policy for the target analysis program (S1080). For example, information representing the identified behavior of the target analysis program (e.g. the address range of input data in the test data), information representing the calculated input index, and information representing the calculated output index are added to the authentication policy. In a case where the data demand information is data demand information about which the developer of the target analysis program and the provider of the analysis data have agreed in advance, the data management unit 400 may register the data demand information, as a part of the authentication policy for the target analysis program, in the authentication policy data, before execution of the target analysis program. The behavior of the data demand information in the authentication policy may be matched against the data demand information on the analysis program to be executed (or the actual behavior of the analysis program) in the first mode.

After S1080 (after exiting the second mode), the data management unit 400 matches the data demand information associated with the target analysis program (containing information indicating the behavior of the target analysis program) against the authentication policy acquired for the target analysis program, thereby determining whether the target analysis program is a trustable program or not (S1100). For example, at least one of the following S1100-1 to S1100-3 is executed. When the determination results of all the executed steps among S1100-1 to S1100-3 are true, the determination result of S1100 is true. When the determination result of at least one step among the executed steps is false, the determination result of S1100 is false.

(S1100-1) The data management unit 400 determines whether the monitored behavior is that specified in the data demand information associated with the target analysis program or not.
(S1100-2) The data management unit 400 determines whether the data demand information associated with the target analysis program matches the authentication policy pertaining to the target analysis program or not. There is a possibility that the data demand information has been rewritten in an unauthorized manner. Consequently, it is significant to determine whether or not the data demand information matches the authentication policy that does not have such a risk.
(S1100-3) The data management unit 400 determines whether the data demand information associated with the target analysis program is information designated in advance (e.g. information without a fear of a high risk) or not.

When the determination result of S1100 is false (S1100: N), the data management unit 400 causes the analysis program authentication unit 300 to execute S1110. Thus, the analysis program authentication unit 300 transmits the authentication failure notification to the request source of the analysis request (core system 700) (S1110).

When the determination result of S1040 is false (S1040: N), the data management unit 400 executes S1100 without entering the second mode (S1050 to S1080). Note that as the target analysis program has not been executed, at least one of S1100-2 and S1100-described above is executed, for example. When the determination results of all the executed steps between S1100-2 and S1100-3 are true, the determination result of S1100 is true. When the determination result of at least one step among the executed steps is false, the determination result of S1100 is false.

When the determination result of S1100 is true (S1100: Y), the data management unit 400 enters the first mode (S1130 to S1160).

First, the data management unit 400 reads at least a part of the input data for executing the target analysis program into the input buffer 450, and configures data output enabling (S1130). The input data is data read from the analysis source data according to the input definition of the data demand information. The configuration of the data output enabling allows the data management unit 400 to output the data output as the result of analysis and stored in the output buffer 490 to the outside of the data management unit 400 (out of the edge system 100).

Next, the data management unit 400 permits the analysis program execution unit 200 to execute the target analysis program (S1140). The analysis program execution unit 200 thus executes the target analysis program.

Next, the data management unit 400 executes 51150. For example, the data management unit 400 acquires the authentication policy pertaining to the target analysis program, from the authentication policy storage resource 500. The data management unit 400 determines the permissibility of access to the input data on the basis of at least one of the acquired authentication policy and the data demand information associated with the target analysis program. In a case where the access is allowed, the data stored in the input buffer 450 is input into the analysis program 230 and analyzed, and data as an analysis result is stored in the output buffer 490. The data management unit 400 monitors the behavior of the target analysis program. The data management unit 400 calculates the input index (e.g., the amount of input data and the input data entropy), and the output index (e.g., the amount of output data and the output data entropy). The data management unit 400 calculates the index deviation and the behavior deviation.

Lastly, the data management unit 400 updates the authentication policy for the target analysis program (S1160). For example, information representing the identified behavior of the target analysis program (e.g. the address range of input data in the test data), information representing the calculated input index, and information representing the calculated output index are added to the authentication policy.

After S1160 (after exiting the first mode), the data management unit 400 determines whether the target analysis program is a trustable program or not, more specifically, whether to permit output of data in the output buffer 490 or not (S1180). For example, at least one of the following S1180-1 to S1180-3 is executed. When the determination results of all the executed steps among S1180-1 to S1180-3 are true, the determination result of S1180 is true. When the determination result of at least one step among the executed steps is false, the determination result of S1180 is false. Both of the following thresholds A and B (B1 and B2) may be determined according to information designated by the user through a user interface, such as GUI, and configured in the authentication policy, or contained in the data demand information.

(S1180-1) The data management unit 400 determines whether the behavior deviation is less than the threshold A or not. For example, the data management unit 400 configures the monitored behavior and the behavior indicating the authentication policy to have values, such as the amounts of characteristics, and determines whether the difference between the values is less than the threshold A or not.
(S1180-2) The data management unit 400 determines whether the output data conforms to the output definition in the data demand information or not.
(S1180-3) The data management unit 400 determines whether the index deviation is equal to or larger than the threshold B or not. For example, at least one of the following determinations is made. The determination of S1180-3-2 may be executed when the determination result of S1180-3-1 is true.
(S1180-3-1) The data management unit 400 determines whether the deviation in the amount of data, which is the difference between the amount of input data and the amount of output data, is equal to or larger than the threshold B1 or not.
(S1180-3-2) The data management unit 400 determines whether the entropy deviation, which is the difference between the input data entropy and the output data entropy, is equal to or larger than the threshold B2 (e.g. the input and output entropy difference exemplified in FIG. 5) or not.

When the determination result of S1180 is false (S1180: N), the data management unit 400 causes the analysis program authentication unit 300 to execute S1110. Thus, the analysis program authentication unit 300 transmits the authentication failure notification to the request source of the analysis request (core system 700) (S1110).

When the determination result of S1180 is true (S1180: Y), the data management unit 400 transmits the output data (analysis result data) to the request source of the analysis request (core system 700) (S1190).

According to the Embodiment described above, if the target analysis program is untrustable, this fact is identified to thereby prevent the data pertaining to analysis from leaking. More specifically, for example, the data demand information associated with the analysis program (information indicating the behavior of the program) is matched against the authentication policy having been registered in advance in conformity with the analysis program; the matching authenticates that the operation of the program is a regular analysis operation, thereby allowing the security to be improved. The data output from the analysis program is also monitored. When the data does not satisfy the preset reference, the data can be prevented from being output.

Although the Embodiment has been described above, the Embodiment is only exemplified for the sake of description of the present invention. There is no intention to limit the scope of the present invention only to the Embodiment. The present invention can be implemented in other various modes.

What is claimed is:

1. A computer system for managing analysis source data, comprising:
an interface unit that is one or more interfaces configured to receive an analysis program; and
a processor unit that is one or more processors coupled to the interface unit and is configured to execute the analysis program,
wherein the processor unit is configured to
(A) calculate one or more types of deviations, based on a behavior of the analysis program, and
(B) control whether or not to output, to an outside of the computer system, output data that is data output as a result of analysis by the analysis program, based on the calculated one or more types of deviations.

2. The computer system according to claim 1,
wherein the one or more types of deviations include an index deviation that is a deviation between an input index and an output index,
the input index is an index pertaining to input data that is input, for analysis, into the analysis program,
the output index is an index pertaining to the output data, and
in (B), the processor unit is configured to
(b1) determine whether the index deviation is equal to or larger than a threshold or not, and
(b2) output the output data to the outside of the computer system, when a determination result of (b1) is true.

3. The computer system according to claim 2,
wherein the index deviation is a deviation in an amount of data,
the deviation in the amount of data is a deviation between the input data and the output data, and
in (b1), the processor unit is configured to
(b1-1) determine whether the deviation in the amount of data is equal to or larger than a first threshold or not.

4. The computer system according to claim 3,
wherein the index deviation is not only the deviation in the amount of data but also an entropy deviation that is a deviation between an entropy of the input data and an entropy of the output data, and
in (b1), the processor unit is configured to
(b1-2) further determine whether the entropy deviation is equal to or larger than a second threshold or not, when a determination result of (b1-1) is true, and
when a determination result of (b1-2) is also true, the processor unit is configured to output the output data to the outside of the computer system in (b2).

5. The computer system according to claim 4,
wherein data demand information is associated with the received analysis program,
the data demand information includes information indicating the behavior of the analysis program, and at least one between the first threshold and the second threshold,
the one or more types of deviations include a behavior deviation that is a deviation between an actual behavior of the analysis program and a behavior indicated by the data demand information, and
in (B), the processor unit is configured to
(b3) determine whether the behavior deviation is less than a third threshold or not, and
output the output data to the outside of the computer system in (b2), when a determination result of (b3) is also true.

6. The computer system according to claim 5,
wherein the processor unit is configured to
identify a policy corresponding to the received analysis program among one or more policies respectively corresponding to one or more analysis programs, the one or more policies each including a policy pertaining to the behavior of the analysis program corresponding to the policy,
determine whether the data demand information conforms to the identified policy or not, and
execute (A) and (B), when a determination result thereof is true.

7. The computer system according to claim 6,
wherein the behavior indicated by the identified policy is a behavior of the analysis program in a past.

8. The computer system according to claim 2,
wherein the index deviation is an entropy deviation that is a deviation between an entropy of the input data and an entropy of the output data, and
in (b1), the processor unit is configured to determine whether the entropy deviation is equal to or larger than a threshold or not.

9. The computer system according to claim 1,
wherein data demand information is associated with the received analysis program,
the data demand information contains information indicating the behavior of the analysis program,
the one or more types of deviations include a behavior deviation that is a deviation between an actual behavior of the analysis program and a behavior indicated by the data demand information,
in (B), the processor unit is configured to further determine whether the behavior deviation is less than a threshold or not, and
when a determination result thereof is also true, the processor unit is configured to output the output data to the outside of the computer system.

10. A method of monitoring execution of an analysis program,
Wherein a computer system for managing analysis source data receives an analysis program,
executes the analysis program,
calculates one or more types of deviations, based on a behavior of the analysis program, and
controls whether or not to output, to an outside of the computer system, output data that is data output as a result of analysis by the analysis program, based on the one or more types of calculated deviations.
